(19) United States
(12) Patent Application Publication
(10) Pub. No.: US 2015/0040758 A1
(43) Pub. Date: Feb. 12, 2015

(54) METHOD AND APPARATUS FOR CRYOGEN-FREE CONCENTRATION OF A HYPERPOLARIZED GAS IN A CONTINUOUSLY FLOWING STREAM OF GAS, AND USE

(71) Applicant: Bundesrepublik Deutschland, vertreten durch das Bundesministerium für Wirtschaft und Arbeit, Diese, Braunschweig (DE)

(72) Inventors: Wolfgang KILIAN, Berlin (DE); Lorenz MITSCHANG, Berlin (DE); Sergey KORCHAK, Berlin (DE)

(73) Assignee: Bundesrepublik Deutschland, vertreten durch das Bundesministerium für Wirtschaft und Arbeit, Diese, Braunschweig (DE)

(21) Appl. No.: 14/453,664

(22) Filed: Aug. 7, 2014

(30) Foreign Application Priority Data
Aug. 9, 2013 (DE) 10 2013 013 197.9

(51) Int. Cl. B01D 53/22; B01D 71/12; B01D 71/16; B01D 71/08

(52) U.S. Cl. CPC B01D 53/22; B01D 53/228; B01D 71/08; B01D 71/12; B01D 71/16
USPC 95/47; 95/45; 95/53; 95/55; 95/50; 96/4

(57) ABSTRACT

The present disclosure refers to a method and an apparatus for cryogen-free concentration of a hyperpolarized noble gas in a continuously flowing stream of gas. The method comprises the following steps: providing a mixture of gases containing hyperpolarized noble gas and at least one process gas; passing the prepared gas mixture as a continuously flowing stream of gas through a gas separation device with a semipermeable membrane in order to separate the gases; and concentrating the hyperpolarized noble gas in the gas separation device, in which at least part of the at least one process gas or the hyperpolarized noble gas is separated from the continuously flowing stream of gas by means of the semipermeable membrane. It also provides for the use of a continuous stream of gas with concentrated hyperpolarized noble gas for magnetic resonance spectroscopy or magnetic resonance tomography.

The present disclosure relates to a method and an apparatus for cryogen-free concentration of a hyperpolarized noble gas in a continuously flowing stream of gas, and to a use of a continuous stream of gas with concentrated hyperpolarized noble gas.

### BACKGROUND

Hyperpolarized noble gases (³He, ⁸³Kr ¹²⁹Xe) can be produced and used for magnetic resonance spectroscopy (MRS) or magnetic resonance tomography (MRT) (see, for example, US 5 642 625). When using known methods for the hyperpolarization of ¹²⁹Xe, in addition to the xenon gas at a partial pressure of a few 100 mbar, gaseous nitrogen also has to be mixed in, in order to suppress the rubidium fluorescence (quenching gas); its partial pressure is approximately 100 mbar to 500 mbar. In order to obtain sufficient light absorption through the vaporized rubidium in the heated pumping cell so as not to operate at an under-pressure, a further buffer gas has to be mixed with it, so that total pressures of at least one to a few atmospheres are obtained in the pumping cell. Usually, the buffer gas used is natural helium, which thus is in the majority in the total stream of gas through the pumping cell.

When mixing the gas in situ, the mixing ratio can be adjusted using three mass flow controllers (MFC) and the gas mixture is continuously pumped into the pumping cell. In order to separate the hyperpolarized ¹²⁹Xe from the two process gases (quenching gas and buffer gas), in the prior art, downstream of the pumping cell, the stream of gas is fed through a cold trap (U.S. Pat. No. 7,373,782 B2). In this glass cell, immersed in liquid nitrogen, the xenon freezes to ice and snow, but the helium and nitrogen remain gaseous and are discharged downstream of a regulating valve (PID pressure regulator, for example) to the surroundings. After accumulation of a sufficient quantity of hyperpolarized ¹²⁹Xe, the whole process has to be stopped, the remaining process gases helium and nitrogen have to be pumped out of the cold trap and then the xenon is thawed out.

That process of freezing and thawing runs the enormous risk of losing the non-equilibrium state of the hyperpolarization and constitutes a process which is difficult to master. In addition, that process cannot be used for the continuous provision of highly polarized and highly concentrated ¹²⁹Xe gas. In order to ensure this, in the prior art, the thawed hyperpolarized ¹²⁹Xe is trapped in a TEDLAR® bag and continuously supplied to the experiment under pressure. The additional residence time in the plastic bag leads also to further losses of polarization.

Attempts have been made to replace the buffer gas with nitrogen and to raise the partial pressure of the xenon in order to obtain a continuous stream of hyperpolarized ¹²⁹Xe with a relatively high partial pressure of xenon (cf. Whiting et al, Appl. Phys. B. 106, 775-788, 2012). However, it has been shown that this approach does not provide the best results as regards the polarization which can be obtained (cf. Korchak et al, Appl. Magn. Reson., 44, 65-80, 2013).

Document US 2011/0050228 A1 refers to an agent for magnetic resonance investigations wherein the agent contains hyperpolarized ¹⁵N. A solution is pressure-forced through a semipermeable membrane for preparing a hyperpolarized ¹⁵N-N₂O solution.

Document DE 10 2005 026 604 A1 discloses a method for dissolving a gas with a short-lived physical property in a liquid. The preparation of the liquid and introduction of the gas into the liquid are provided, wherein the gas is introduced via a semipermeable membrane in the liquid provided one side of the membrane.

### SUMMARY

It is an object to provide an improved method and an improved apparatus for cryogen-free concentration of a hyperpolarized noble gas in a continuously flowing stream of gas. In particular, manipulation should be simplified and polarization losses when using highly concentrated hyperpolarized noble gas should be reduced.

According to different aspects, a method and an apparatus for cryogen-free concentration of a hyperpolarized noble gas in a continuously flowing stream of gas are provided. Furthermore, the use of a continuous stream of gas with concentrated hyperpolarized noble gas is provided

A gas separation device with a semipermeable membrane is provided. The gas produced by means of the membrane separator contains a very high fraction of hyperpolarized noble gas and thus can be introduced directly and continuously into an experiment without additional process steps. A selectively permeable membrane is used to produce a continuous gaseous stream of highly concentrated hyperpolarized noble gases.

A method for cryogen-free concentration of a hyperpolarized noble gas in a continuously flowing stream of gas is provided, wherein the method comprises the following steps:

a) providing a mixture of gases containing hyperpolarized noble gas and at least one process gas;

b) passing the prepared gas mixture as a continuously flowing stream of gas through a gas separation device with a semipermeable membrane in order to separate the gases; and

c) concentrating the hyperpolarized noble gas in the gas separation device, in which at least part of the at least one process gas or the hyperpolarized noble gas is separated from the continuously flowing stream of gas by means of the semipermeable membrane.

Separating the at least one process gas or the hyperpolarized noble gas from the continuously flowing stream of gas is carried out by passage through the membrane. As a result, the hyperpolarized noble gas is concentrated. On both sides of the membrane a gas stream may be flowing in the process of gas separation.

The gas-permeable separation membrane can have different permeabilities (semipermeable) for each of the gases involved, especially the at least one process gas and the hyperpolarized noble gas. The method can be configured in such a manner that at least one of the process gases has a substantially higher permeability and the majority of it passes through the membrane as the permeate and thus is separated from the continuous stream of gas, which then contains the hyperpolarized noble gas in a rather more concentrated form. Separation of the permeate may, for example, be improved by using a vacuum pump which draws the permeable process gas from the permeate side. The retentate in this case contains the concentrated hyperpolarized noble gas and can be continuously supplied to the specific technical application.

It is possible for the gas separation membrane to be used in a different manner and for the hyperpolarized gas to have a higher permeability than at least one of the process gases. In this case, the gas mixture which contains the hyperpolarized gas would be the permeate and the less permeable process gas would be the retentate. This depends on the membrane used and the difference between the permeability of the hyperpolarized gas and the permeability of the at least one process gas. The method can be varied accordingly.

The method may be carried out continuously so that the stream of gas which is produced is concentrated continuously.

Examples of semipermeable membranes per se which are suitable for the method are described in document DE 10 2006 044 635. In one embodiment, an example of such a membrane for gas separation has the following features: a porous carrier layer formed from a polymer or inorganic material, in particular a ceramic material, and a separating layer, comprising a mixture of saccharide derivatives and homopolymers, in particular comprising ethyl cellulose, cellulose acetate or poly-4-methyl-1-pentene, wherein the saccharide derivatives have a cyclic structure with five or six ring atoms or a linear structure or are monosaccharide derivatives which are bonded via glycoside linkages, and wherein the number of monosaccharides bonded in this manner is between 2 and 1000.

In one embodiment, the hyperpolarized noble gas is ¹²⁹Xe, ³He or ⁸³Kr.

The volume fraction of the hyperpolarized noble gas, in particular ¹²⁹Xe or ⁸³Kr, in the stream of gas continuously produced in accordance with step c) may be at least 50% higher than in the gas mixture supplied in accordance with step a).

The volume fraction of the hyperpolarized noble gas, in particular ¹²⁹Xe or ⁸³Kr, in the stream of gas continuously produced in accordance with step c) may be 20% by volume to 80% by volume, preferably 50% by volume to 80% by volume. The volume fraction of the hyperpolarized noble gas, in particular ¹²⁹Xe or ⁸³Kr, in the gas mixture prepared in accordance with step a) may be 0.1% by volume to 20% by volume, preferably 2% by volume to 10% by volume.

The volume fraction of krypton in the stream of gas prepared in accordance with step a) may be 1% by volume to 75% by volume (cf. Six et al., PLoS ONE, 7, e49927, 2012), preferably 2% by volume to 10% by volume.

In one embodiment, gas separation by means of the semipermeable membrane results in concentration of the hyperpolarized gas by at least 50%, preferably at least 200%.

In one embodiment of the method, the semipermeable membrane is disposed in a gas separation module. Gas separation modules of this type can be constructed as follows:
using disc-shaped membranes in cylindrical modules with specially constructed spacers (DE 100 01 880 A1);
when using hollow membranes, modules formed from bundles of fibres can be prepared in which the supplied gas mixture (feed) is either fed through the lumens of the hollow fibres and the permeate is pumped from outside (US 2012/0031831), or the gas mixture is guided along the outside of the bundle of fibres and the permeate is pumped out through the hollow fibres;
when using membranes with a honeycomb structure for gas separation (DE 600 11 724), contact with the vessel walls can be minimized.

In one embodiment, the gas separation membrane (membrane for separating the gases) comprises:
a porous carrier layer formed from a polymer or inorganic material, in particular a ceramic material,
a separating layer, comprising a mixture of saccharide derivatives and homopolymers, in particular comprising ethyl cellulose, cellulose acetate or poly-4-methyl-1-pentene, wherein the saccharide derivatives have a cyclic structure with five or six ring atoms or a linear structure or are monosaccharide derivatives which are bonded via glycoside linkages, and wherein the number of monosaccharides bonded in this manner is between 2 and 1000.

In one embodiment of the membrane, the membrane contains 10% to 50% by weight of saccharide derivatives.

In a further advantageous embodiment, the saccharide derivatives comprise structures with formulae STR1, STR2 or STR3 which correspond to:

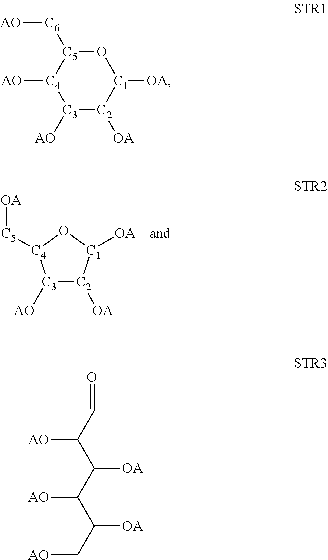

wherein A is hydrogen, a silyl-containing substance or an acetate-containing substance with formula STR4 or STR5, which correspond to:

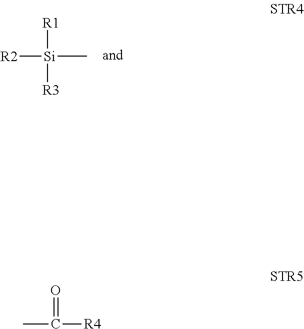

wherein R1, R2, R3 are hydrogen, an alkyl, alkenyl, aryl, alkylaryl or arylalkyl containing 1 to 10 carbon atoms and wherein R4 is an alkyl, alkenyl, aryl, alkylaryl or arylalkyl containing 1 to 10 carbon atoms.

In a particularly preferred embodiment of the membrane, the monosaccharide derivatives bonded via glycoside linkages contain C1-C4, C1-C1 or C1-C6 bonds.

Advantageously, the membrane contains saccharide derivatives which derive from acetylation or silylation of the family of saccharides with a cyclic structure with five or six ring atoms or linear structure, wherein they may be monosaccharose, disaccharose, trisaccharose or dextrin.

In the case of monosaccharose, it preferably comprises at least one member from the group formed by arabinose, lyxose, ribose, deoxyribose, xylose, ribulose, xylulose, allose, altose, galactose, glucose, gulose, idose, mannose, tagatose, fructose, mannoheptulose, sedoheptulose, octolose, 2-keto-3-deoxy-manno-octonate and sialose.

In the case of disaccharose, it preferably comprises at least one member from the group formed by sucrose, lactose, maltose and trehalose.

In the case of dextrin, it preferably comprises at least one member from the group formed by α-cyclodextrin, β-cyclodextrin, γ-cyclodextrin and dextrins with various molecular weights in the range 900 to 1000000 daltons.

In a further advantageous embodiment, the saccharide derivatives are obtained by acetylation or silylation of the high molecular weight saccharide family; this may include cellulose, starches and glycogens.

In a further preferred embodiment of the membrane, the saccharide derivative is obtained to an extent of 75% to 100% by weight by acetylation or silylation, wherein the saccharide derivatives are homogeneously dissolved with the homopolymer in a common organic solvent.

In this case, the saccharide derivatives advantageously have a vanishingly small vapour pressure and are temperature stable up to at least 100° C. In this manner, a long service life and better performance of the membrane are ensured.

In a further advantageous embodiment of the membrane, the separating layer contains 5% to 60% by weight of saccharide derivatives.

Particularly preferably, the carrier layer comprises at least one member from the group formed by polysulphone, polyethersulphone, polyphenylsulphone, polyacrylonitrile, cellulose acetate, polyetherimide and polyimide, or in particular from one or more of these materials.

Methods for the manufacture of these gas separation membranes are also described in document DE 10 2006 044 635.

Further useful gas separation membranes are described in the documents DE 38 79 882 T2, DE 35 10947 A1 and DE 32 25837 A1.

At least one process gas from the following group: He, N₂, H₂, D₂, C₂H₄ and C₃H₆ may be used.

At least two process gases may be used in the prepared gas mixture. One of the two gases is employed as the buffer gas, which can act to broaden the rubidium absorption line. The other will act as the so-called quenching gas (fluorescence quenching), for example to suppress the rubidium fluorescence in the pumping cell. Examples of gases which may be used for fluorescence quenching are N₂, H₂, D₂, C₂H₄ and C₃H₆ Helium, He, can be used as the buffer gas.

In one embodiment of the method, the gas mixture is produced continuously by means of an alkali hyperpolarizer, for example by means of a rubidium hyperpolarizer.

A further aspect concerns the use of a continuous stream of gas produced using the method for cryogen-free concentration of a hyperpolarized noble gas in a stream of gas provided for magnetic resonance spectroscopy (MRS) or magnetic resonance tomography (MRT).

The use of a plurality of gaseous separation apparatuses, each provided with a semipermeable membrane for gas separation, can be provided, for example for the selective separation of quenching gas and/or buffer gas.

### BRIEF DESCRIPTION OF THE FIGURE:

FIG. 1—A diagrammatic representation of a configuration with gas line.

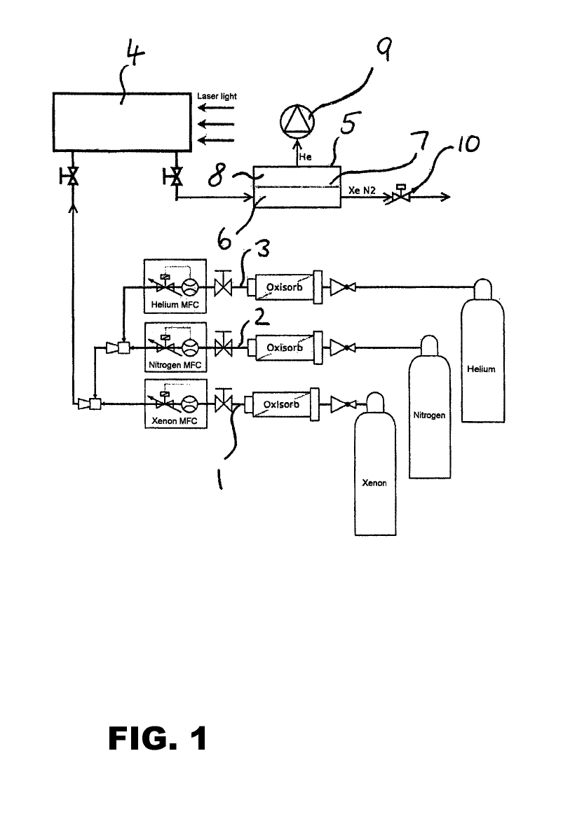

Further exemplary embodiments will now be described in more detail with reference to the figure.

The single figure shows a diagrammatic representation of a configuration with gas line components for cryogen-free concentration of a hyperpolarized noble gas, in particular ¹²⁹Xe, in a continuously flowing stream of gas using a gas separation device with a semipermeable membrane.

Gases are provided via feed devices 1, 2, 3 and can be fed to an optical pumping cell 4.

Downstream of the optical pumping cell 4, the gas mixture is fed continuously through a gas separation device 5 and thereafter directly, or after using a pressure reducer 10, in particular a Teflon® pressure reducer 10, fed to an experiment using MRS or MRT. In the gas separation device 5, the continuous stream of gas flows through a chamber 6 which is separated from an adjacent chamber 8 by a semipermeable membrane 7. One or more process gases are separated out by the semipermeable membrane 7 from the continuously flowing stream of gas, whereupon the volume fraction of the hyperpolarized noble gas in the chamber 6 rises (concentration). Downstream of the gas separation device 5 is the pressure reducer 10.

Using a vacuum pump 9, which in the exemplary embodiment shown pumps the helium on the permeate side out of the adjacent chamber 8, the selective enrichment is increased and the xenon losses are reduced. Once it has been started up, a ¹²⁹Xe polarizer fitted out in this manner can be operated by personnel without problems and the polarized gas in solution can be transferred continuously, for example, using other membrane modules (cf. for example EP 1 901 782).

A membrane supplier's calculations for separating a normal gas composition of 0.4 bars xenon, 0.4 bars nitrogen and 3.2 bars helium for a total flow of 0.5 L/min through the pumping cell 4 upstream of the gas separation device 5 show a reduction in the fraction of helium to less than 0.1% by volume, whereas the fraction of xenon is over 54% by volume and less than 10% of xenon gas penetrates through the membrane 7 and thus is lost on the permeate side by being drawn up by the vacuum pump 9 (assumption: 0.1 bar pressure on the permeate side).

A further increase in the xenon volume fraction downstream of the gas separation device 5 can be obtained by using a quenching gas which diffuses substantially better through the membrane 7 than is the case with nitrogen, but nevertheless has a high fluorescence quenching cross-section. Hydrogen (H₂), deuterium (D₂), ethene (C₂H₄) or propene (C₃H₆) are of particular application here.

In a similar manner to the situation regarding hyperpolarized ¹²⁹Xe, a gas separation module 5 of this type can also be used to enrich hyperpolarized ⁸³Kr. In this case a decision is made as to whether the krypton is to be the permeate or retentate for the membrane employed.

In a complementary manner to the situation described for hyperpolarized ¹²⁹Xe, a gas separation module 5 of this type can also be used to enrich hyperpolarized ³He gas. In this case, the lighter hyperpolarized ³He gas is filtered out of a gas mixture, as opposed to the heavier nitrogen gas (fluorescence quencher).

The features disclosed in the present description, claims and figure can be used both individually and in any combination to generate the various embodiments.

Without further elaboration, it is believed that one skilled in the art can, using the preceding description, utilize the present invention to its fullest extent. The preceding preferred specific embodiments are, therefore, to be construed as merely illustrative, and not limitative of the remainder of the disclosure in any way whatsoever.

In the foregoing and in the examples, all temperatures are set forth uncorrected in degrees Celsius and, all parts and percentages are by weight, unless otherwise indicated.

The entire disclosures of all applications, patents and publications, cited herein and of corresponding German Application No. DE 10 2013 013 197.9, filed Aug. 9, 2013 are incorporated by reference herein.

The preceding examples can be repeated with similar success by substituting the generically or specifically described reactants and/or operating conditions of this invention for those used in the preceding examples.

From the foregoing description, one skilled in the art can easily ascertain the essential characteristics of this invention and, without departing from the spirit and scope thereof, can make various changes and modifications of the invention to adapt it to various usages and conditions.

1. A method for cryogen-free concentration of a hyperpolarized noble gas in a continuously flowing stream of gas, comprising:
a) providing a mixture of gases containing hyperpolarized noble gas and at least one process gas;
b) passing the prepared gas mixture as a continuously flowing stream of gas through a gas separation device with a semipermeable membrane in order to separate the gases; and
c) concentrating the hyperpolarized noble gas in the gas separation device, in which at least part of the at least one process gas or the hyperpolarized noble gas is separated from the continuously flowing stream of gas by means of the semipermeable membrane.

2. The method as claimed in claim 1, wherein the continuously flowing stream of gas in the gas separation device flows along a surface of the semipermeable membrane.

3. The method as claimed in claim 1, wherein the process gas separated by means of the semipermeable membrane is drawn off.

4. The method as claimed in claim 1, wherein the hyperpolarized noble gas is ¹²⁹Xe, 89 or ³He.

5. The method as claimed in claim 1, wherein a volume fraction of the hyperpolarized noble gas in the stream of gas produced in accordance with step c) is at least 50% higher than in the gas mixture supplied in accordance with step a).

6. The method as claimed in claim 1, wherein the method is carried out continuously and thus the continuously flowing stream of gas is concentrated continuously.

7. The method as claimed in claim 1, wherein the semipermeable membrane comprises the following features:
a porous carrier layer formed from a polymer or inorganic material, in particular a ceramic material, and
a separating layer, comprising a mixture of saccharide derivatives and homopolymers, in particular comprising ethyl cellulose, cellulose acetate or poly-4-methyl-1-pentene,
wherein the saccharide derivatives have a cyclic structure with five or six ring atoms or a linear structure or are monosaccharide derivatives which are bonded via glycoside linkages, and wherein the number of monosaccharides bonded in this manner is between 2 and 1000.

8. The method as claimed in claim 1, wherein at least one process gas is selected from the following group of process gases: He, N₂, H₂, D₂, C₂H₄ and C₃H₆.

9. The method as claimed in claim 1, wherein the gas mixture which is prepared contains at least two process gases.

10. The method as claimed in claim 1, wherein the gas mixture is prepared continuously by means of an alkali hyperpolarizer.

11. An apparatus for cryogen-free concentration of a hyperpolarized noble gas in a continuously flowing stream of gas, comprising:
a gas mixing device for the preparation of a gas mixture containing hyperpolarized noble gas and at least one process gas; and
a gas separation device having a semipermeable membrane for gas separation, wherein the gas separation device is in fluid communication with the gas mixing device in a manner such that the prepared gas mixture can be introduced as a continuously flowing stream of gas into the gas separation device and at least a portion of the at least one process gas or the hyperpolarized noble gas can be separated therein from the continuously flowing stream of gas by means of the semipermeable membrane in order to concentrate the hyperpolarized noble gas.

12. Use of a continuous stream of gas with concentrated hyperpolarized noble gas produced in accordance with a method as claimed in claim 11, for magnetic resonance spectroscopy or magnetic resonance tomography
